(19) United States
(12) Patent Application Publication
(10) Pub. No.: US 2017/0220307 A1
(43) Pub. Date: Aug. 3, 2017

(54) MULTI-SCREEN MOBILE DEVICE AND OPERATION

(71) Applicant: Samsung Electronics Co., Ltd., Gyeonggi-Do (KR)

(72) Inventors: Heron Da Silva Ramos, San Mateo, CA (US); Tussanee Garcia-Shelton, San Mateo, CA (US); Jae Namkung, San Jose, CA (US); Nasson Jullian Schahin Boroumand, Gold River, CA (US); Rachel Kobetz, San Jose, CA (US)

(21) Appl. No.: 15/013,100

(22) Filed: Feb. 2, 2016

(51) Int. Cl. G06F 3/14; G06F 3/0488; G06F 1/32; G06F 1/16; G06F 3/0484

(52) U.S. Cl. CPC G06F 3/1423; G06F 1/1647; G06F 3/04845; G06F 1/3265; G06F 3/04842; G06F 3/04883; G06F 1/1641

(57) ABSTRACT

Operating a mobile device having a plurality of display units may include, responsive to executing an application on the mobile device, determining, using a processor of the mobile device, a sensor of the mobile device used by the application and determining, using the processor, which of the plurality of display units includes the sensor used by the application. The mobile device may display, using the processor, the application on a screen of the display unit that includes the sensor used by the application.

### TECHNICAL FIELD

This disclosure relates to a multi-screen mobile device and, more particularly, to operation of the multi-screen mobile device.

### BACKGROUND

Mobile devices have become pervasive. Many of the mobile devices currently in use have a single screen. Single screen mobile devices typically include a physical keyboard or use a touch-sensitive screen as part of the interface through which a user may interact. Single screen mobile devices are technologically mature and, as such, have well-defined user interaction models.

Multi-screen mobile devices provide users with an extended visual workspace. Presently, however, multi-screen mobile devices are not as pervasive as single screen mobile devices. Further, available user interaction models for multi-screen mobile devices are not well-defined when compared to single screen mobile devices. Without clear user interaction models, multi-screen mobile devices may be less intuitive to operate and, as such, less useful to users than single screen mobile devices despite the potential advantages of having additional screens.

### SUMMARY

An embodiment may include a method of operating a mobile device having a plurality of display units. The method may include, responsive to executing an application on the mobile device, determining, using a processor of the mobile device, a sensor of the mobile device used by the application and determining, using the processor, which of the plurality of display units includes the sensor used by the application. The method may include displaying, using the processor, the application on a screen of the display unit that includes the sensor used by the application.

Another embodiment may include a mobile device. The mobile device may include a plurality of display units coupled to one another and configured to rotate about an axis, wherein each display unit includes a screen. The mobile device may include a processor within at least one of the display units. The processor may be programmed to initiate executable operations that include, responsive to executing an application, determining a sensor of the mobile device used by the application, determining which of the plurality of display units includes the sensor used by the application, and displaying the application on the screen of the display unit that includes the sensor used by the application.

Another embodiment may include a computer program product. The computer program product may include a computer readable storage medium having program code stored thereon. The program code may be executable by a processor of a mobile device having a plurality of display units to perform a method. The method may include, responsive to executing an application on the mobile device, determining, using the processor of the mobile device, a sensor of the mobile device used by the application and determining, using the processor, which of the plurality of display units includes the sensor used by the application. The method also may include displaying, using the processor, the application on a screen of the display unit including the sensor used by the application.

This Summary section is provided merely to introduce certain concepts and not to identify any key or essential features of the claimed subject matter. Many other features and embodiments of the invention will be apparent from the accompanying drawings and from the following detailed description.

### BRIEF DESCRIPTION OF THE DRAWINGS

The accompanying drawings show one or more embodiments; however, the accompanying drawings should not be taken to limit the invention to only the embodiments shown. Various aspects and advantages will become apparent upon review of the following detailed description and upon reference to the drawings.

FIG. 1 is a diagram illustrating an exemplary mobile device.

FIG. 2 is a perspective view of the mobile device of FIG. 1 in a closed arrangement.

FIG. 3 is a block diagram illustrating an exemplary hardware architecture the mobile device of FIG. 1.

FIG. 4 is a diagram illustrating an exemplary low power mode for the mobile device of FIG. 1.

FIG. 5 is a flow chart illustrating an exemplary method of operation using a low power mode for a mobile device.

FIG. 6 is a diagram illustrating exemplary assistant views that may be displayed on a screen of the mobile device of FIG. 1.

FIG. 7 is a diagram illustrating an exemplary implementation of an intelligent assistant mode for the mobile device of FIG. 1.

FIG. 8 is another diagram illustrating the intelligent assistant mode for the mobile device of FIG. 1.

FIG. 9 is a diagram illustrating an exemplary implementation of a multitask mode for the mobile device of FIG. 1.

FIG. 10 is a diagram illustrating an exemplary peek view mode for the mobile device of FIG. 1.

FIG. 11 is another diagram illustrating peek view mode for the mobile device of FIG. 1.

FIG. 12 is a diagram illustrating an exemplary application drawer mode for the mobile device of FIG. 1.

FIG. 13 is another diagram illustrating application drawer mode for the mobile device of FIG. 1.

FIG. 14 is another diagram illustrating application drawer mode for the mobile device of FIG. 1.

FIG. 15 is a diagram illustrating an exemplary content recommendation mode for the mobile device of FIG. 1.

FIG. 16 is another diagram illustrating content recommendation mode for the mobile device of FIG. 1.

FIG. 17 is a diagram illustrating an exemplary gesture pad mode for the mobile device of FIG. 1.

FIG. 18 is a diagram illustrating another exemplary mode of operation for the mobile device of FIG. 1.

FIG. 19 is a flow chart illustrating an exemplary method of managing applications for the mobile device of FIG. 1.

FIG. 20 is a diagram illustrating an exemplary software navigation mode for the mobile device of FIG. 1.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to a multi-screen mobile device and, more particularly, to operation of the multi-screen mobile device. In accordance with the inventive arrangements described herein, user interaction models are provided that facilitate intuitive use and navigation of the multi-screen mobile device. The user interaction models allow the user to perform complex tasks and interact seamlessly with the multi-screen mobile device in less time and in a way that places less cognitive load on the user compared to conventional modes of interaction.

For example, users may easily switch among applications, view multiple applications concurrently, and navigate applications using the multiple screens of the mobile device. Further, the mobile device may provide users with supplemental or contextually relevant information on one screen thereby allowing the user to continue performing a task on another screen of the mobile device. The mobile device effectively relieves the user from having to switch between applications and/or views within an application to obtain the information necessary for completion of the task.

The various user interaction models referenced above and described within this disclosure are implemented as operation modes and/or features of the multi-screen mobile device. In one aspect, these operation modes and/or features may be implemented within the operating system and/or applications of the multi-screen mobile device. Further aspects of the inventive arrangements are described in greater detail below with reference to the drawings.

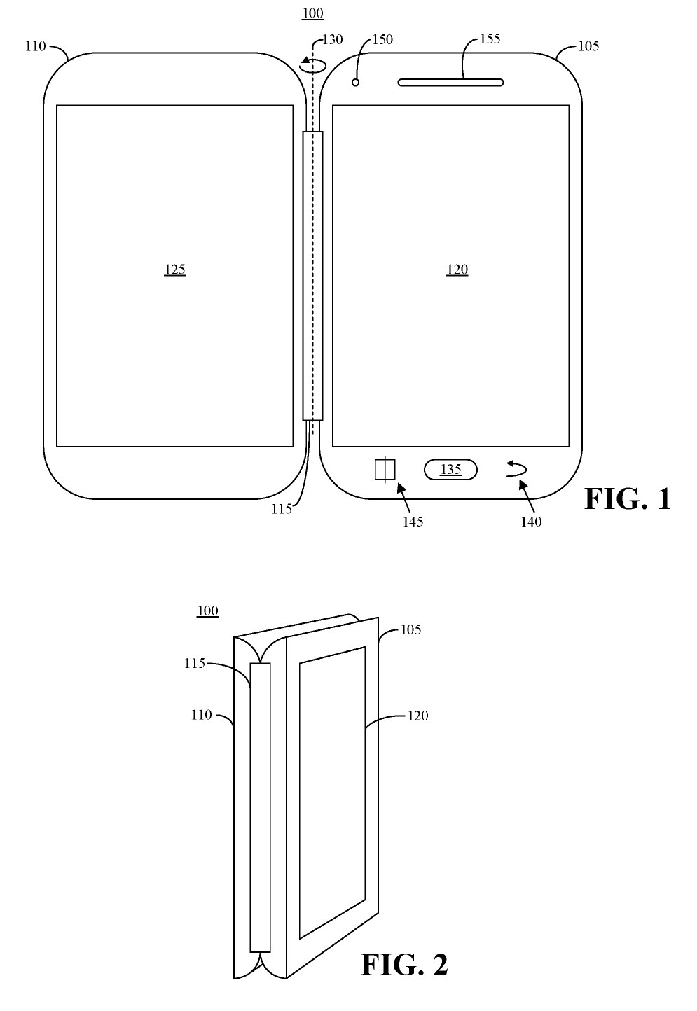

FIG. 1 is a diagram illustrating an exemplary mobile device 100. Examples of a mobile device may include, but are not limited to, a “smart” phone, a tablet computer, a mobile media device, and a game console, a mobile Internet device, a personal digital assistant, a laptop computer, a mobile appliance device, or the like. In the example of FIG. 1, mobile device 100 is implemented using a handheld form factor.

As pictured, mobile device 100 includes a display unit 105 and a display unit 110. Hinge 115 couples display unit 105 with display unit 110. Hinge 115, for example, may mechanically couple display units 105 and 110. Further, display unit 105 may be communicatively linked with display unit 110 via circuitry (not shown) within hinge 115. Display unit 105 may include a screen 120. Display unit 110 may include a screen 125. In one aspect, screens 120 and 125 may be implemented as touch-sensitive screens. Further, screens 120 and 125 may be color screens capable of displaying motion graphics, video, video games, and the like.

In one embodiment, hinge 115 may be configured to allow each of display units 105 and 110 to swivel or rotate around an axis 130. Axis 130 may be oriented parallel to the lengthwise orientation of hinge 115. In general, display units 105 and 110 may be folded into a closed arrangement. In one aspect, hinge 115 may be configured to allow display units 105 and 110 to rotate around axis 130 so that screens 120 and 125 face inward toward each other. In this configuration, referred to as the “closed inward” arrangement, neither screen 120 nor screen 125 is viewable by a user. In another aspect, hinge 115 may be configured to allow display units 105 and 110 to rotate around axis 130 so that screens 120 and 125 face outward away from each other. In this configuration, referred to as the “closed outward” arrangement, both screens 120 and 125 are viewable by a user though not concurrently since the user would need to flip or turn mobile device 100 to view the rear facing screen. It should be appreciated that both the closed inward arrangement and the closed outward arrangement are considered “closed arrangements” within this disclosure. As pictured in FIG. 1, mobile device 100 is in an open arrangement.

In one exemplary implementation, display units 105 and 110 may include one or more sensors. In one aspect, the sensors included in display units 105 and 110 may be the same. In another aspect, the sensors included in display units 105 and 110 may be different. In another example, one or more sensors may be included in each of display units 105 and 110, while one or more other sensors may be included in only display unit 105 or in only display unit 110. In still another exemplary implementation, display units 105 and 110 may be configured so that only display unit 105 includes sensors while display unit 110 includes no sensors. For purposes of discussion and determining which sensors may be included in display unit 105 and/or display unit 110, any sensors that may be part of screen 120 and/or screen 125 that implement touch sensitivity are not considered “sensors”.

In the example of FIG. 1, display unit 105 may include sensors such as one or more hardware controls. As pictured, the hardware controls of display unit 105 may include a home button 135, a back button 140, and a multitask mode button 145. Display unit 105 may also include a hardware power button (not shown) and a hardware volume button (not shown). Display unit 110 may not include any hardware controls.

Other exemplary sensors of display unit 105 may include a camera 150 and a speaker 155. Mobile device 100 may include another camera (not shown) facing the opposite direction of camera 150 within either display unit 105 and/or display unit 110. Display unit 105 may also include a microphone as a sensor. The microphone is not shown in FIG. 1.

In general, mobile device 100 may operate and/or control screen 120 and screen 125 independently of one another whether displaying information or receiving user input. As such, a user has independent control over both of screens 120 and 125. For example, screen 120 and screen 125 may display applications and/or content concurrently. Further screens 120 and 125 may display applications and/or content independently of one another.

In one embodiment, mobile device 100 may be implemented with display unit 105 being the primary unit and display unit 110 being the secondary unit. Display unit 110, for example, and more particularly, screen 125, may be used as an assistant screen. The assistant screen may display one or more different assistant views. Mobile device 100 may display the assistant views on screen 125 independently of, and concurrently with, any content and/or applications displayed on screen 120.

FIG. 2 is a perspective view of mobile device 100 in a closed arrangement. More particularly, FIG. 2 illustrates mobile device 100 in the outward closed arrangement. As pictured, display units 105 and 110 are back-to-back allowing screen 120 and screen 125 (not shown) to face outward from mobile device 100 so that each of screens 120 and 125 may be viewed by a user. As noted, while in the outward closed arrangement, screens 120 and 125 are not viewable by a same user concurrently. For ease of illustration, hardware controls 135, 140, and 145 are not shown in FIG. 2.

In one embodiment, while mobile device 100 is in the closed outward arrangement, screen 125 may be turned off. While mobile device 100 is in the closed outward arrangement, screen 125 is likely not facing the user. Accordingly, mobile device 100 may turn off screen 125 to prevent screen 125 from displaying any information, while screen 120 may be turned on to display information. In one embodiment, screen 125 may be turned off entirely so that screen 125 does not display any information and does not detect touch input from a user. In another embodiment, screen 125 may be turned off so as not to display information but maintain touch sensitivity so as to detect touch input from a user.

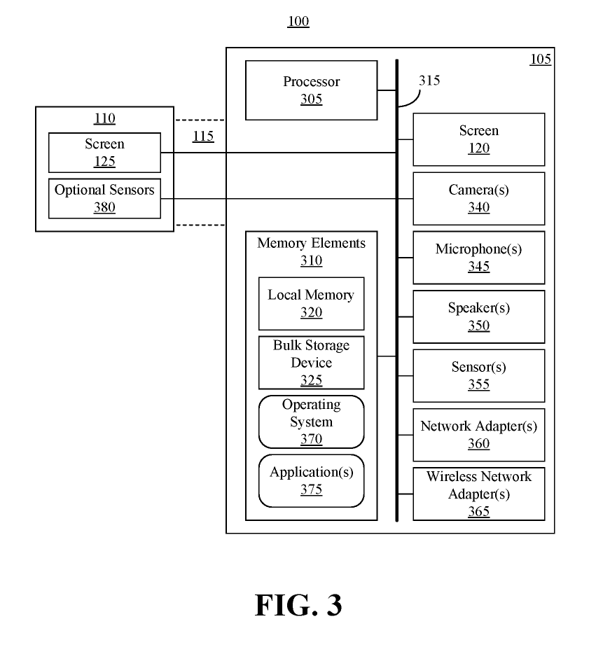

FIG. 3 is a block diagram illustrating an exemplary hardware architecture for mobile device 100. The architecture illustrated in FIG. 3 may be used to implement any of a variety of different multi-screen devices that include a processor and memory that are capable of performing the operations described within this disclosure.

Display unit 105 includes at least one processor 305 coupled to memory elements 310 through a system bus 315 or other suitable circuitry such as an input/output (I/O) subsystem. Mobile device 100 stores program code within memory elements 310. Processor 305 executes the program code accessed from memory elements 310 via system bus 315. Memory elements 310 include one or more physical memory devices such as, for example, a local memory 320 and one or more bulk storage devices 325. Local memory 320 refers to random access memory (RAM) or other non-persistent memory device(s) generally used during actual execution of the program code. Bulk storage device 325 may be implemented as a hard disk drive (HDD), solid state drive (SSD), or other persistent data storage device. Display unit 105 may also include one or more cache memories (not shown) that provide temporary storage of at least some program code in order to reduce the number of times program code must be retrieved from bulk storage device 325 during execution.

Display unit 105 may also include screen 120 and one or more sensors including, but not limited to, one or more camera(s) 340 (e.g., front and/or rear facing), one or more microphone(s) 345, and/or one or more speaker(s) 350. Display unit 105 further may include one or more other sensors 355, one or more network adapter(s) 360, and/or one or more wireless network adapter(s) 365. Screen 120, camera(s) 340, microphone(s) 345, speaker(s) 350, sensor(s) 355, network adapter(s) 360, and wireless network adapter(s) 365 may be coupled to processor 305 and/or memory elements 310 through system bus 315. Examples of sensors 355 may include, but are not limited to, an accelerometer, a light sensor, one or more biometric sensors, a gyroscope, a compass, or the like. Screen 120, camera(s) 340, microphone(s) 345, speaker(s) 350, other sensor(s) 355, network adapter(s) 360, and wireless network adapter(s) 365 may be coupled to system bus 315 either directly or through intervening I/O controllers.

Network adapter(s) 360 may be implemented as communication circuits configured to establish wired communication links with other devices. The communication links may be established over a network or as peer-to-peer communication links. Exemplary network adapter(s) 150 may include, but are not limited to, modems, cable modems, Ethernet ports. Wireless network adapter(s) 365 may be implemented as wireless transceivers configured to establish wireless communication links with other devices. Exemplary wireless network adapter(s) 365 may include, but are not limited to short range wireless transceivers (e.g., Bluetooth® compatible transceivers and/or 802.11x (Wi-Fi™) compatible transceivers), long range wireless transceivers (e.g., cellular transceivers) or the like. Accordingly, network adapter(s) 360 and wireless network adapters 365 enable mobile device 100 to become coupled to other systems, computer systems, remote printers, and/or remote storage devices.

As pictured in FIG. 3, memory elements 310 may store an operating system 370 and one or more application(s) 375. In one aspect, operating system 370 and application(s) 375, being implemented in the form of executable program code, are executed by mobile device 100 and, more particularly, by processor 305 of display unit 105. As such, operating system 370 and application(s) 375 may be considered an integrated part of mobile device 100. Operating system 370, application(s) 375, and any data items used, generated, and/or operated upon by mobile device 100 are functional data structures that impart functionality when employed as part of mobile device 100.

Display unit 110 may be coupled to display unit 105 by hinge 115. As pictured, display unit 110 may include screen 125 and one or more optional sensor(s) 380. Examples of optional sensors 380 may include, but are not limited to, one or more camera(s) (e.g., front and/or read facing cameras), one or more microphone(s), one or more speaker(s), an accelerometer, a light sensor, one or more biometric sensors, a gyroscope, a compass, or the like. Screen 120 and optional sensors 380 may be coupled to, e.g., communicatively linked to, system bus 315 via circuitry either directly or through intervening I/O controllers.

In one exemplary arrangement, one or more of sensors 355 may be located within hinge 115 to detect the arrangement (or position) of display unit 105 relative to display unit 110. The sensor may indicate whether mobile device 110 is in the closed inward arrangement, the closed outward arrangement, open, or the like. In the case where mobile device 100 is open, the sensor may indicate the degree or another measure of the arrangement of display unit 105 relative to display unit 110 about axis 130, e.g., the angle formed between display unit 105 and display unit 110 about hinge 115 and/or axis 130.

Mobile device 100 may include fewer components than shown or additional components not illustrated in FIG. 3. Further, one or more of the illustrative components may be incorporated into, or otherwise form a portion of, another component. For example, a processor may include at least some memory.

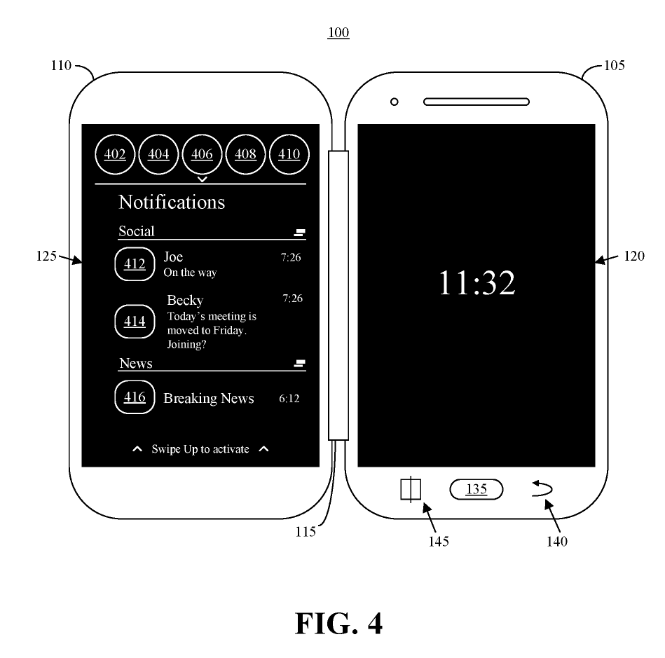

FIG. 4 is a diagram illustrating an exemplary low power mode for mobile device 100. In one embodiment, mobile device 100, at least initially, may be in a standby mode. In standby mode, both of screens 120 and 125 may not display information, e.g., be turned off. Further, mobile device 100 may disable touch sensitivity of one or both of screens 120 and 125. Mobile device 100 may enter a low power mode responsive to being opened from a closed arrangement, whether the closed inward arrangement or the closed outward arrangement.

In another embodiment, mobile device 100 may enter low power mode from a standby mode responsive to a tap of screen 120 and/or 125. In that case, while mobile device 100 may turn screens 120 and 125 off, mobile device 100 may keep touch sensitivity of screen 120 and/or screen 125 on or active.

Responsive to entering low power mode, screens 125 and 130 may become operative by displaying information using a low power mode color scheme. As defined within this disclosure, the term “low power mode color scheme” means a color scheme that uses a dark background with lighter colored text and/or images. In one example, the low power mode color scheme may be black and white. In another example, the low power mode color scheme may be gray scale. The low power mode color scheme, for example, may be limited to two colors including a dark background color and a lighter foreground color used to display information against the dark background color. While using the low power mode color scheme, any images, colors, or the like used as backgrounds for home screens and/or desktops may be suppressed and only solid, dark colors may be used as the background on screen 120 and/or screen 125. For example, screens 120 and 125 may display information using a black or other dark color background with a lighter foreground color such as white or a shade of gray that is lighter than the background. Using a dark or black background allows mobile device 100 to conserve power while screens 120 and/or 125 are actively displaying information.

In one arrangement, while operating in low power mode, screen 125 may display one of a plurality of assistant views. Available assistant views that may be displayed on screen 125 may include, but are not limited to, a task view, a notification view, and a control view. In the example of FIG. 4, the user has selected the notification view as the default assistant view. Accordingly, responsive to entering low power mode, mobile device 100 may cause screen 125 to be operative using only a low power mode color scheme to display the default assistant view, e.g., the notification view in this example.

In the notification view, screen 125 displays a row of selectable icons 402, 404, 406, 408, and 410. In the example of FIG. 4, icons 402, 404, 406, 408, and 410 may be on/off switches that may be selected by a user for activating and/or deactivating different sensors and/or operation modes of mobile device 100. For example, icons 402, 404, 406, 408, and/or 410 may be used to activate and/or deactivate the Bluetooth® transceiver, the WiFi™ transceiver, to place mobile device 100 in an airplane mode where all wireless transceivers are deactivated, muting the sound on mobile device 100, and/or the like. Within the notification view, several notifications from different applications, as indicated by icons 412, 414, and 416, may also be shown. The notifications further may be organized according to category such as “social,” “news,” or the like.

Screen 120, while in low power mode, may also present information using a low power mode color scheme as described for screen 125. In the example of FIG. 4, screen 120 may display the time. In other arrangements, screen 120 may display the date, the date and time, and/or other limited information. In one aspect, the user may select particular data items that may be displayed on screen 120 and/or screen 125 while in low power mode. For example, referring to the notifications on screen 125, a user may select particular types of notifications that may be displayed in low power mode to address user privacy concerns. Any notifications not selected by the user may not be displayed on screen 125 while mobile device 100 operates in low power mode. Notifications not selected for display and not displayed on the notification view while mobile device 100 is in the low power mode may be shown in the notification view when mobile device 100 is not in low power mode (e.g., when in a normal mode of operation).

In one arrangement, mobile device 100 may exit low power mode responsive to a user input. For example, the user input may be a gesture such as a swipe from the lower portion or bottom of screen 125 up in the direction indicated by the “A” symbols. Responsive to detecting the user input, mobile device 100 may exit low power mode. Accordingly, mobile device 100 may enter a normal operation mode. In the normal operation mode, mobile device 100 may activate screens 120 and/or 125 to use a normal operation mode color scheme. The normal operation mode color scheme may use colors in an unrestricted manner. Further, any images and/or pictures used as backgrounds for home screens or desktops on screens 120 and/or 125 may be enabled and displayed in full color. Upon exiting low power mode, screen 125 may continue to display the notification view, for example, in color without restriction as to color scheme. Similarly, upon exiting low power mode screen 120 may begin operating in color without restriction as to color scheme.

As defined within this disclosure, the term “gesture” means a touch user input. The touch user input may be a touch of a single fingertip (or other pointing device that may be used with a touch-sensitive screen in lieu of a fingertip) and/or multiple fingertips. The touch user input may be one or more fingertips remaining in contact with a touch-sensitive screen for a predetermined amount of time, motion of one or more fingertips in a particular direction and/or pattern, or any combination of the foregoing. Screen 120, when in normal operation mode, may display a home screen such as a desktop view.

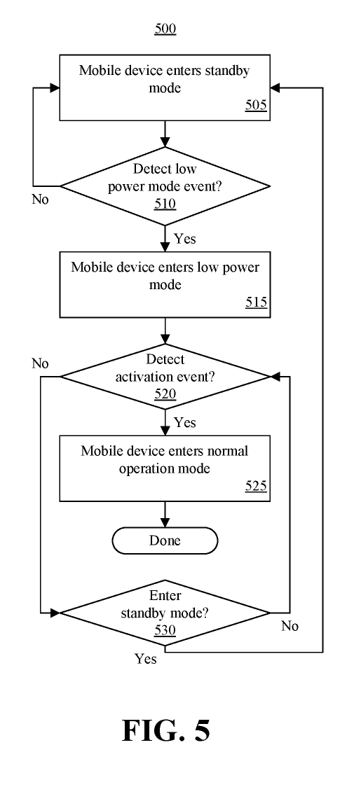

FIG. 5 is a flow chart illustrating an exemplary method 500 of operation using low power mode for mobile device 100. In block 505, mobile device 100 may operate in standby mode. For example, mobile device 100 may be in a closed arrangement where both screen 120 and screen 125 are off so as not to display any information.

In block 510, mobile device 100 may determine whether a low power mode event has been detected. If so, method 500 may proceed to block 515. If not, method 500 may loop back to block 505 to continue monitoring for a low power mode event. In one aspect, the low power mode event may be detecting that display units 105 and 110 have rotated about axis 130 so that mobile device 100 is no longer in the closed arrangement. For example, display units 105 and 110 may be in an open arrangement. As used within this disclosure, the term “open arrangement” may mean any arrangement or positioning of mobile device 100 where display units 105 are not screen-to-screen (in closed inward arrangement) and not back-to-back (in closed outward arrangement).

In block 515, responsive to detecting the low power mode event, mobile device 100 may enter low power mode. Accordingly, responsive to entering low power mode, mobile device 100 may display information on screens 120 and 125 using the low power mode color scheme as described with reference to FIG. 4. In block 520, mobile device 100 may determine whether an activation event has been detected. An activation event may be a particular type of user input such as an upward swipe on screen 120 and/or 125. If an activation event is detected, method 500 may proceed to block 525. If no activation event is detected, method 500 may continue to block 530.

In block 525, mobile device 100 may enter normal operation mode. Responsive to entering normal operation mode, mobile device 100 exits low power mode. Further, in entering normal operation mode, mobile device 100 causes screen 120 and screen 125 to begin operating using the normal operation mode color scheme. For example, each of screen 120 and 125 may display the last view shown on each respective screen prior to entering standby mode. After block 525, method 500 may end.

Continuing with block 530, mobile device 100 may determine whether to enter standby mode. If so, method 500 may loop back to block 505. In standby mode, both of screens 120 and 125 may be turned off so as not to display any information. If mobile device 100 determines not to enter standby mode, method 500 may loop back to block 520 to continue monitoring for an activation event.

In one example, mobile device 100 may remain in low power mode for a predetermined amount of time without detecting an activation event. Responsive to determining that an activation event has not been received for, and/or during, the predetermined amount of time, mobile device 100 may exit low power mode and proceed to block 505 to enter standby mode. In another example, mobile device 100 may enter standby mode responsive to detecting that mobile device 100 has been placed in a closed arrangement.

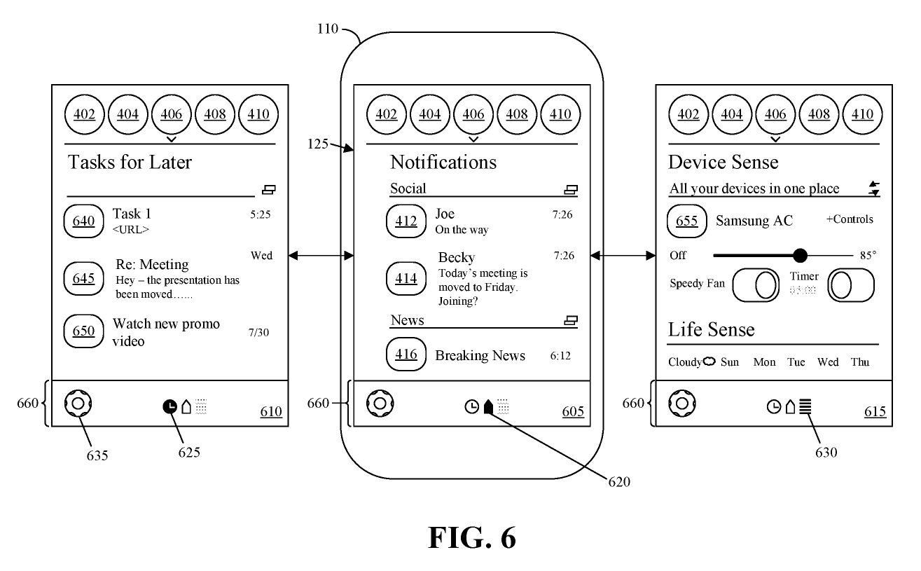

FIG. 6 is a diagram illustrating exemplary assistant views that may be displayed on screen 125 of mobile device 100. In one arrangement, display unit 110 may be utilized as a secondary display unit. Accordingly, in certain contexts, e.g., by default, when in the normal operation mode, screen 125 may display one of a plurality of different assistant views shown as notification view 605, task view 610, and control view 615. In general, the user may switch between view 605, 610, and/or 615 on screen 125 using one or more user inputs such as gestures.

For purposes of illustration, view 605 may be displayed initially on screen 125 as the default assistant view. In that case, indicator 620 may be illuminated or highlighted indicating notifications view 605 is shown. Responsive to a user input such as a gesture swiping to the right, task view 610 may be displayed on screen 125. In that case, when task view 610 is displayed on screen 125, indicator 625 may be illuminated. Alternatively, responsive to a user input such as gesture swiping to the left, control view 615 may be displayed on screen 125 with indicator 630 illuminated. In the example of FIG. 6, indicators 620, 625, and 630 may be positioned relative to one another to indicate the relative positioning of assistant views 605, 610, and 615, respectively. Seeing which of indicators 620, 625, or 630 is illuminated indicates which direction to swipe to display other assistant views on screen 125. It should be appreciated, however, that views 605, 610, and 615 may be positioned relative to one another in any order and that the positioning of views 605, 610, and 615 illustrated within this disclosure is for purposes of illustration only.

Views 605, 610, and/or 615 may be displayed on screen 125 responsive to the gestures independently of any application, content, or view displayed on screen 120. The view displayed on screen 120, for example, may remain unchanged, whether a video, an application, a home screen, or the like, while the user switches between views 605, 610, and/or 615 on screen 125.

In one aspect, a user may select view 605, 610, or 615 as a default view for screen 125. Responsive to a user selection of settings icon 635, for example, mobile device 100 may present a user interface through which the user may specify one of views 605, 610, or 615 as the default view. Accordingly, in any operating state where an assistant view is presented, mobile device 100 may display the default assistant view. For example, referring to the low power mode illustrated in FIG. 4, the default assistant view may be shown on screen 125.

Notification view 605 has been described with reference to FIG. 4. Task view 610 may display a list of tasks for the user. In the example shown in FIG. 6, each task may be associated with an icon such as icons 640, 645, and 650. In one arrangement, the icon may represent a particular application with which the task is associated. Icon 640 may indicate that the task is associated with a universal resource locator (URL). Icon 645 may indicate that the task is associated with a text message. Icon 650 may indicate that the task is associated with another application such as a calendar application, a video application, or the like. Further, for each task, one or more controls may be displayed allowing the user to edit aspects of the task such as the subject of the task, due date, reminders, and the like.

Control view 615 may display a list of controls for one or more other devices that may be accessible using mobile device 100. For example, a user may choose to install one or more widgets for controlling devices such as thermostats, appliances, and/or other devices considered part of the “Internet of Things” or “IoT.” A “widget” refers to an installed application that may expose one or more controls or data items in a view where controls and/or data items from multiple widgets may be displayed concurrently. The controls of the widgets, once installed on mobile device 100, may be viewed in control view 615 on screen 125. Icon 655 illustrates a widget for controlling a climate control system. Control view 615 may also display weather information, or the like.

In one aspect, the lower portion 660 of each of views 605, 610, and 615 may be a ribbon that is displayed over the assistant view. If the assistant view requires more screen than is available, the user may scroll through the view while lower portion 660 remains displayed over the underlying view scrolling beneath.

In one embodiment, views 605, 610, and 615 may be different home screens for screen 125 of mobile device 100. A home screen refers to a lowest layer of a user interface for screens 120 and/or 125. Other views (e.g., applications) may be layered and displayed over the home screen of displays 120 and/or 125 as mobile device 100 operates and the user executes applications. Selecting home button 135, for example, causes mobile device 100 to display the home screen on each of displays 120 and/or 125.

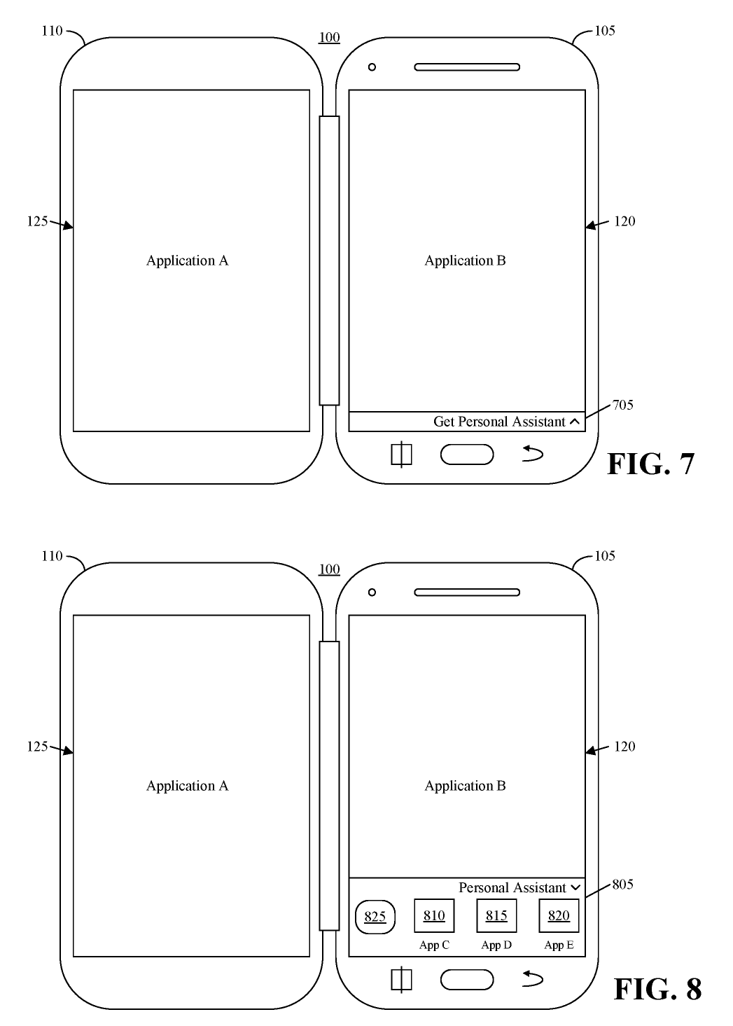

FIG. 7 is a diagram illustrating an exemplary implementation of an intelligent assistant mode for mobile device 100. Mobile device 100 may initiate intelligent assistant mode automatically responsive to detecting a particular operating context on mobile device 100. For example, mobile device 100 may learn which applications a user opens and/or uses concurrently based upon historical usage. Based upon the historical usage, mobile device 100 may suggest applications and/or available features through the intelligent assistant mode.

In the example of FIG. 7, a user is using two applications referred to as application A and application B concurrently. Application A may be displayed on screen 125 concurrently with application B on screen 120. Responsive to detecting a particular operating context, i.e., application A and application B executing concurrently and both being displayed concurrently on a screen of mobile device 100, mobile device 100 may display a message such as “Get Personal Assistant” in region 705 of screen 120. Region 705 may be a narrow ribbon displayed over the current view displayed on screen 120, e.g., over application B. Region 705 may be referred to as an intelligent assistant notification.

It should be appreciated that an operating context may be determined from a single application displayed on screen 120 and/or screen 125, from two applications displayed concurrently on screens 120 and 125, from one or more other functions of mobile device 100 being used and/or accessed, the arrangement and/or orientation of mobile device 100, a particular operating mode of mobile device 100 (e.g., standby, low power, normal operating, etc.), or the like. In any case, responsive to detecting a particular operating context, region 705 may be displayed.

Region 705 may be removed after a predetermined amount of time if the user chooses not to utilize the intelligent assistant mode. For example, after displaying region 705 for a predetermined amount of time without receiving a user input confirming a desire to use the intelligent assistant mode, mobile device 100 may remove region 705. If the user does provide a user input indicating a desire to use the intelligent assistant mode, mobile device 100 may display the intelligent assistant. In the example of FIG. 7, the user may indicate a desire to use the intelligent assistant by touching region 705 and swiping, or pulling, up in the direction of the symbol “A”.

FIG. 8 is another diagram illustrating the intelligent assistant mode for mobile device 100. FIG. 8 illustrates a state of mobile device 100 responsive to a user input indicating a desire to use the intelligent assistant mode. For example, responsive to the user gesture, mobile device 100 may display an expanded region 805 referred to as the “intelligent assistant.” Region 805 may include one or more icons 810, 815, and/or 820 for applications “App C,” “App D,” and “App E”. In this example, mobile device 100 has determined that while using application A and application B, the user, at least historically, has also used application C, application D, and/or application E. Other suggestions may also be presented such as Websites and the like that are determined to be relevant to the current context or that were accessed in previous instances of the current recognized context (e.g., historically). Accordingly, the applications are suggested in region 805 as part of the intelligent assistant mode.

Region 805 further includes a control 825. Control 825 may be displayed responsive to mobile device 100 determining that an application displayed on screen 120 and/or 125 may be expanded to utilize both screens of mobile device 100. For example, selection of control 825 may cause mobile device 100 to expand the display of application A or application B to utilize both of screens 120 and 125. It should be appreciated that the functionality invoked by control 825 must be implemented in the particular application that is executing and/or displayed on a screen of mobile device 100 while the intelligent assistant mode is invoked. If the application executing and displayed does not support dual screen operation, then control 825 may be disabled or not displayed at all. In another embodiment, an additional icon 825 may be displayed in the event that both of applications A and B may operate in a dual screen mode. The user may select which application to expand. In the case where a single icon 825 is displayed, the icon may indicate the particular application that may be expanded to dual screen operation.

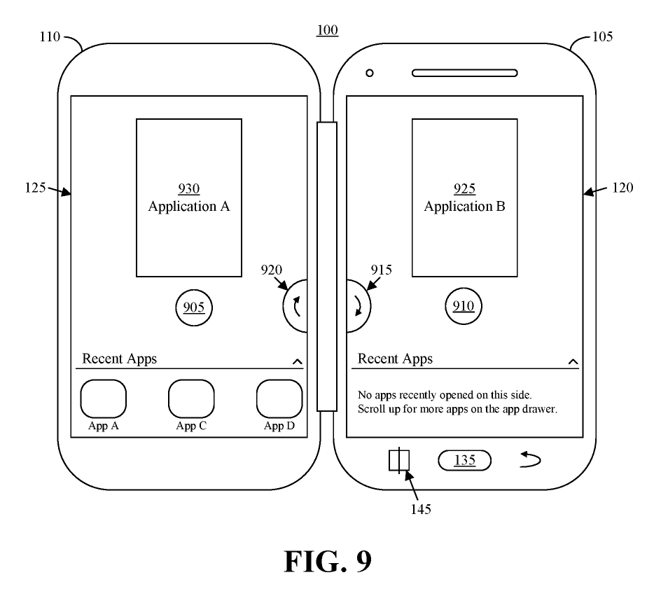

FIG. 9 is a diagram illustrating an exemplary implementation of a multitask mode for mobile device 100. In the example of FIG. 9, a user may invoke multitask mode using a predetermined user input. In one embodiment, a user may invoke multitask mode using home button 135. For example, the user may double tap home button 135. In another embodiment, multitask mode may be invoked responsive to a user selection of multitask mode button 145. Multitask mode provides for fast and efficient switching among applications and application management in a single place.

Responsive to the user input invoking multitask mode, the application displayed on screen 120 and the application displayed on screen 125 may be reduced in size so as not to consume the entirety of each respective screen. Prior to activation of multitask mode, for example, application A and application B may have been displayed in full screen. As defined within this disclosure, the term “full screen” means that an application, when executed, is displayed using the entirety of a given screen of mobile device 100. For example, consider the case where application B is executing and consumes the entirety of screen 120 while application A is executing and consumes the entirety of screen 125. Responsive to the user input invoking multitask mode, the views for application A and application B may be reduced in size and displayed on screens 125 and 120, respectively, within regions 930 and 925.

In one arrangement, a control 905 may be displayed on screen 125. Control 905 may be a “pin application control.” Selection of control 905 may cause the application above control 905, e.g., application A, to be pinned, or remain displayed, on screen 125. Accordingly, responsive to a user selection of control 905, application A will be pinned to screen 125 and become the home screen that is displayed for screen 125. In another example, mobile device 100, responsive to selection of control 905, may query the user as to which screen the application is to be pinned. In this example, the user is provided with the ability to choose whether to pin an application to screen 120 or to screen 125.

In one embodiment, an application that is pinned takes over the “lowest” level of the user interface on screen 125. For example, responsive to pinning an application, the pinned application may be displayed in any mode or context that an assistant application, e.g., assistant views 605, 610, or 615, would otherwise be displayed. In illustration, responsive to pinning an application and a subsequent user input pressing home button 135, mobile device 100 would display the pinned application on screen 125 as the home screen in lieu of an assistant screen or other desktop view and display the home screen, i.e., a desktop view, on screen 120. In general, users may execute applications that are viewed on screens 120 and 125 and continually “stack up” applications on either one or both of screens 120 and/or 125. Responsive to the user selecting home button 135, mobile device 100 displays the lowest level of user interface on each of screens 120 and 125, i.e., a home screen (e.g., a desktop type view) on screen 120 and the pinned application on screen 125. If an application is not pinned to screen 125, mobile device 100 displays the selected assistant view.

A control 910 may be displayed on screen 120. Control 910 may be a create combination shortcut control. Selection of control 910 may cause mobile device 100 to create a combination shortcut that may be displayed in a view shown on screen 120 and/or 125. Combination shortcuts, for example, may be displayed on a home screen of mobile device 100 as part of a desktop view. The combination shortcut may be displayed as an icon among other icons of available applications. The combination shortcut is an object, represented by a visual element, that, when selected, executes two or more applications for concurrent use.

In the example of FIG. 9, user selection of control 910 causes a combination shortcut to be created using application A and application B (e.g., the particular applications in regions 925 and 930). A subsequent user selection of the combination shortcut, as represented by an icon on a screen of mobile device 100, executes application A and application B. In one aspect, the combination shortcut further causes the applications, e.g., application A and application B, to be displayed on the particular screen that each application was displayed when the combination shortcut was created. As such, a combination shortcut created by selecting control 910 in FIG. 9, when executed, will execute applications A and B, display application A on screen 125, and display application B on screen 120. The icon representing the combination shortcut may be a combination of the icon of application A and the icon of application B.

In one arrangement, screens 120 and 125 may include controls 915 and 920, respectively. Selection of either one of controls 915 or 920 causes mobile device 100 to swap applications between screens 120 and 125. For example, responsive to selecting control 915 or control 920, application A may be displayed on screen 120 and application B displayed on screen 125. Use of controls 915 and/or 920 allows a user to position applications as desired whether for pinning to screen 125, for creating combination shortcuts as described, or for general usage upon exiting multitask mode.

In another arrangement, a user may move an application from one screen to another using a gesture such as swiping on the screen in the direction that the user wishes the application to move while in multitask mode. For example, mobile device 100 may display application A on screen 120 over application B responsive to a user swipe on screen 125 to the right while in multitask mode. Mobile device 100 may display application B on screen 125 over application A responsive to a user swipe on screen 120 to the left while in multitask mode. It should be appreciated that the operations described move only one particular application from one screen to another as opposed to swapping applications between screens as described with reference to controls 915 and/or 920.

In still another arrangement, an application may be dismissed or terminated responsive to a user gesture swiping outward while in multitask mode. For example, mobile device 100 may terminate or dismiss application A responsive to a gesture swiping to the left on screen 125. Similarly, mobile device 100 may terminate or dismiss application B responsive to a gesture swiping to the right on screen 120.

In a lower region of each of screens 120 and 125, while in multitask mode, mobile device 100 may display a list of recent applications. The recent applications may be applications that are currently executing. In one embodiment, the applications displayed in the list of recent applications may be screen specific. For example, the list of recent applications on screen 125 may include only those recently used applications that were displayed on screen 125. Similarly, the list of recently used applications displayed on screen 120 may include only those applications that were recently used and displayed on screen 120. In the example of FIG. 9, the user recently used application A, application C, and application D on screen 125. No applications were recently used on screen 120. It should be appreciated that the “No apps” text is shown for purposes of illustration. In another example, application B may be listed since Application B is currently executing and had been displayed on screen 120.

In one aspect, each of the recently used regions may be expanded responsive to a user gesture such as swiping or pulling up on the screen at or near the location indicated. For example, the user may swipe up from the “Recent Apps” text and or the up symbol “A” to expand the list of recent applications on either one or both of screens 120 and/or 125. Further, it should be appreciated that each of screens 120 and 125 may be operated independently of the other in terms of accessing and/or expanding recently used applications.

In the case where no recent applications are shown as is the case for screen 120, the user may provide a gesture such as swiping up to implement the application drawer mode to be described herein in greater detail.

Selecting a recently used application causes that application to be displayed on the screen from which the application was selected. For example, responsive to the user selecting application C from the recent applications region of screen 125, mobile device 100 may display application C in lieu of application A while remaining in the multitask mode. Mobile device 100 would display application C in reduced size in region 930 in lieu of application A, while mobile device 100 continues to display the various controls described.

In another arrangement the recent applications region may not be screen specific. In that case, the “recent applications” region of each of screens 120 and 125 may display the same applications regardless of the screen upon which the applications were displayed. Accordingly, the list of recent applications including application A, application C, and application D (and also application B), may be displayed on each of screens 120 and 125. In this example, a user may select a particular application from the recent applications region that causes mobile device 100 to display that application in region 930 and/or 935 according to the particular screen from which the user selected the application. For example, responsive to a user selection of application D from the recent applications region of screen 125, application D may be displayed in region 930 in place of Application A. Responsive to a user selection of application D from the recent applications region of screen 120, application D may be displayed in region 925.

A user may exit multitask mode by selecting an application in either region 925 or region 930 of screen 120 or screen 125, respectively. Selecting an application in one of regions 925 or 930 causes mobile device 100 to exit multitask mode and display the applications shown in regions 925 and 930 in full screen on each of screens 120 and 125, respectively.

Mobile device 100 may provide an additional interaction model for switching applications from one screen to another. In another embodiment, a detected user input such as a gesture may cause mobile device 100 to display controls 915 and 920 thereby allowing users to swap the screen used to display applications as described. As an example, the user input may be a force touch. Controls 915 and 920 may be displayed while the applications on each of screens 120 and 125 remain in full screen view. In that case, mobile device 100 may not enter multitask mode as described, but rather enter a mode that allows the user to move applications from one screen to another, swap applications, and/or dismiss applications. In another example, however, the detected user input may cause mobile device 100 to enter multitask mode as described.

In still another example, responsive to detecting the user input, the application on the screen upon which the user input was detected may provide an indication that mobile device 100 has entered a mode in which the user may move applications from one screen to another (e.g., without entering multitask mode as described with reference to FIG. 9). For example, mobile device 100 may highlight the edges of the application. The user may then provide further input such as a swipe to move the application from one screen to another, dismiss application(s), or the like.

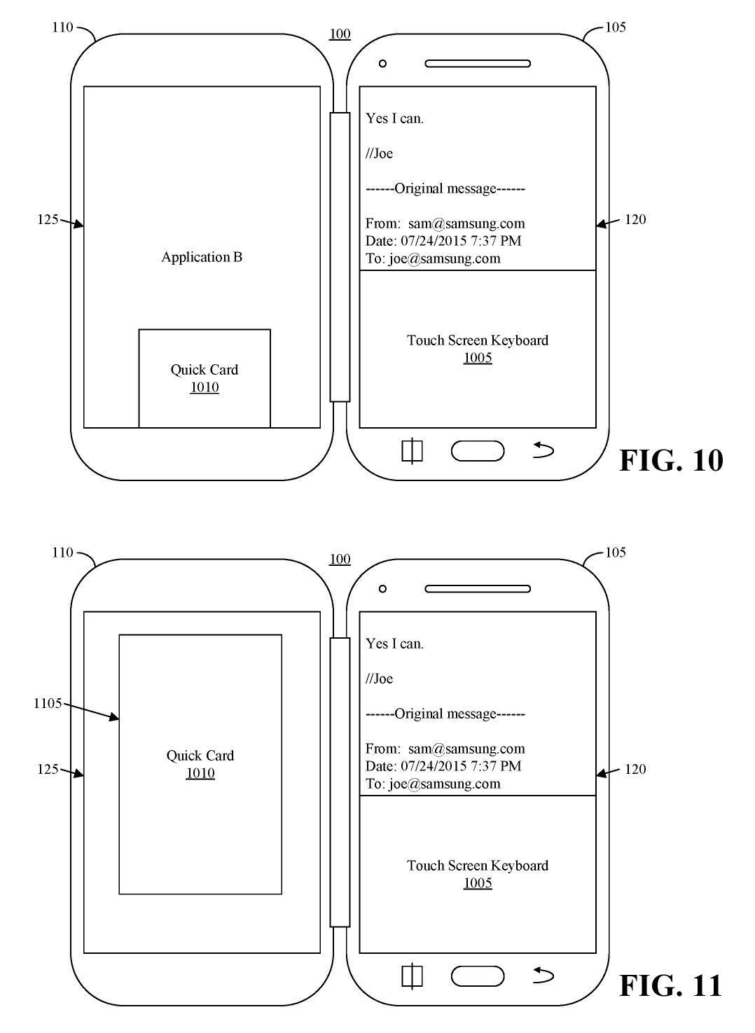

FIG. 10 is a diagram illustrating an exemplary peek view mode for mobile device 100. In one aspect, peek view mode may be a function that must be supported on a per application basis. In the example of FIG. 10, mobile device 100 is executing an electronic mail application that is displayed on screen 120. A different application, referred to as application B, is displayed on screen 125. Responsive to a user input selecting a “reply” operation within the electronic mail application, mobile device 100 may display a touch screen keyboard 1005 on screen 120. Further, mobile device 100 may display quick card 1010 on screen 125. Quick card 1010 may be partially displayed over application B or any other content shown on screen 125. Quick card 1010 may be used to provide additional information that may be useful to a user in performing a particular task such as replying to an electronic mail in this example, forwarding an electronic mail, etc.

In one arrangement, peek view mode may be implemented automatically responsive to detecting particular actions within applications that support the peek view mode. Exemplary actions may include replying to a message within a messaging application such as an electronic mail application, a text messaging application, or other communication application, forwarding a message, detecting or selecting an attachment, etc. The particular content that may be displayed as quick card 1010 may depend upon the particular application executing and the action(s) being performed. In one aspect, mobile device 100 may remove quick card 1010 if a user input indicating a desire to use peek view mode is not received within a predetermined amount of time. If a user input indicating a desire to use peek view mode is received within the predetermined amount of time, mobile device 100 may display a complete view of quick card 1010.

FIG. 11 is another diagram illustrating peek view mode for mobile device 100. In the example of FIG. 11, a user input is received indicating a desire to use peek view mode. For example, a user input such as a gesture touching quick card 1010 in FIG. 10 may be received. The gesture may be a touch of quick card 1010 or a swipe up from quick card 1010. Responsive to the user input, mobile device 100 may display quick card 1010 in its entirety in region 1105 of screen 125. In the example of FIGS. 10 and 11, quick card 1010 may display the content of the original electronic mail message to which the user is replying on screen 125. Peek view mode provides the user with additional information in performing the task of replying to a message. In this example, the user may write a reply electronic mail message using screen 120 while viewing the particular electronic mail, or contents of the electronic mail, to which the user is replying on screen 125. Peek view mode relieves the user from having to continually scroll up and down to reference the original electronic mail while composing the reply electronic mail. Another exemplary implementation of peek view mode may allow a user to view an attachment to a message as quick card 1010.

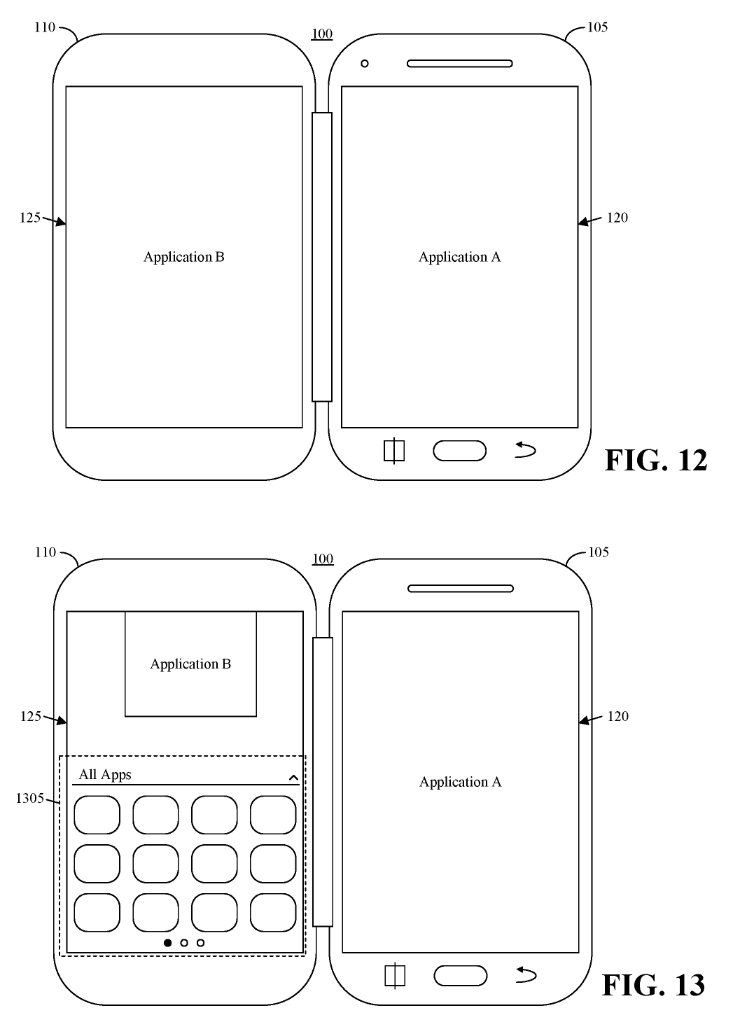

FIGS. 12 and 13 are diagrams illustrating an exemplary implementation of an application drawer mode for mobile device 100. As pictured in FIG. 12, mobile device 100 may be executing applications A and B. Application A is displayed on screen 120 in full screen. Application B is displayed on screen 125 in full screen. In one arrangement, application drawer mode may be invoked responsive to a user input. For example, the user input may be a gesture swiping up from the bottom of either one of screens 120 or 125.

Referring to FIG. 13, responsive to the user input, an application drawer 1305 is shown on screen 125. Application drawer 1305 lists the installed applications available for execution on mobile device 100. In the example of FIG. 13, the user input was received through screen 125. Accordingly, responsive to the received user input invoking application drawer mode, mobile device 100 displays application drawer 1305 on screen 125. In this example, application drawer 1305 includes icons representing installed applications as the list. If the user input invoking application drawer mode is received through screen 120, mobile device 100 may display an application drawer on screen 120.

It should be appreciated that a user may invoke application drawer mode and cause an application drawer to be displayed on screen 120 only, on screen 125 only, or on both screens 120 and 125 depending upon which screen or screens the user provides the user input invoking application drawer mode. As noted, screens 120 and 125 may operate independently of one another and, in this regard, each may display an application drawer responsive to receiving a user input invoking application drawer mode on that respective screen.

On each screen that an application drawer is displayed while in application drawer mode, any application previously displayed on the screen in full screen may be reduced in size and shifted above the application drawer. As pictured in FIG. 13, as application drawer 1305 is displayed and rises upward from the bottom of screen 125, application B is reduced in size and is shifted above application drawer 1305. With application drawer 1305 displayed, a user may select an application from application drawer 1305 for execution. The selected application may be executed and displayed on screen 125 in full screen.

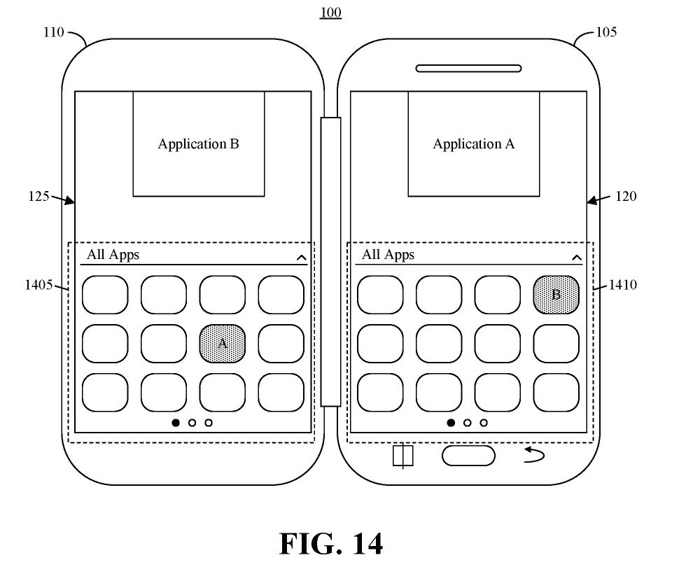

FIG. 14 is another diagram illustrating application drawer mode for mobile device 100. In the example of FIG. 14, application drawer mode is invoked. A user has provided a user input invoking application drawer mode on each of screens 120 and 125 independently. In one aspect, applications that are already executing in the foreground of a screen may be shown as unavailable. For example, since application A is executing and displayed in the foreground of screen 120, the icon representing application A in application drawer 1405 on screen 125 is grayed out indicating that selecting application A from application drawer 1405 is not an available option. Similarly, since application B is executing and displayed in the foreground of screen 125, the icon representing application B in application drawer 1410 on screen 120 is grayed out indicating that selecting application B from application drawer 1410 is not an available option.

In another exemplary embodiment, the application drawer mode may used to change the screen on which an application is viewed. Referring again to FIG. 14, in another example, application A and application B may not be grayed out. In that case, responsive to a user input selecting application A from application drawer 1405 on screen 125, mobile device 105 may move application A from screen 120 to screen 125. Application A may be visually distinguished from other applications in application drawer 1405 to indicate selection of application A will cause application A to be displayed on a different screen than is currently the case as illustrated in FIG. 14.

Similarly, responsive to a user input selecting application B from application drawer 1410 on screen 120, mobile device 100 may move application B from display 125 to display 120. Application B may be visually distinguished from other applications in application drawer 1410 to indicate selection of application B will cause application B to be displayed on a different screen than is currently the case as illustrated in FIG. 14. When an application is moved in this manner, the application may move to the other screen and be shown in reduced form. Upon exit from application drawer mode on a screen, the application shown in reduced form on that screen may return to full screen.

Application drawer mode allows a user to launch an application on mobile device 100 without having to exit a current application by pressing the home button to return to the home screen. A user may seamlessly invoke the application drawer mode while using one or more applications to launch a desired application.

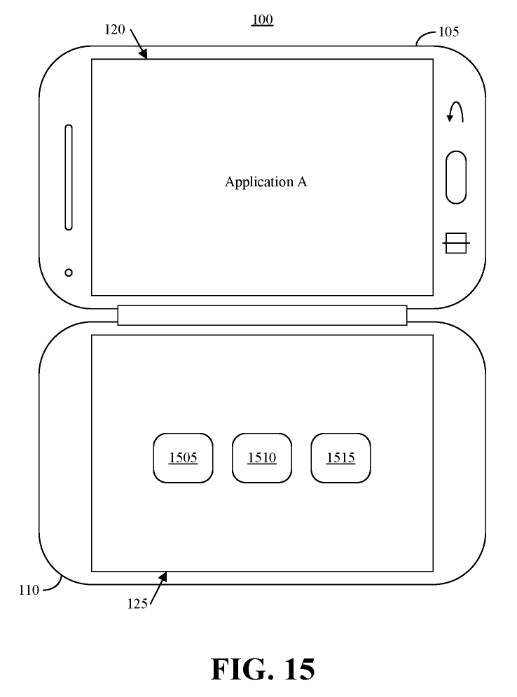

FIG. 15 is a diagram illustrating an exemplary content recommendation mode for mobile device 100. As pictured, mobile device 100 is in an open arrangement and oriented in a landscape arrangement with screen 120 positioned above screen 125. Mobile device 100 is executing application A in landscape mode with application A being displayed on screen 120. Further, mobile device 100 displays application A in full screen. In one exemplary embodiment, recommended applications, Websites, and/or other content such as books, movies, games, and the like determined to be related to application A may be displayed on screen 125 as one or more selectable icons 1505, 1510, and/or 1515. In one example, application A may be a video game. The recommended applications may be another application or a Website that provides tips and/or tricks for playing application A. Information on screen 125 may be displayed in landscape.

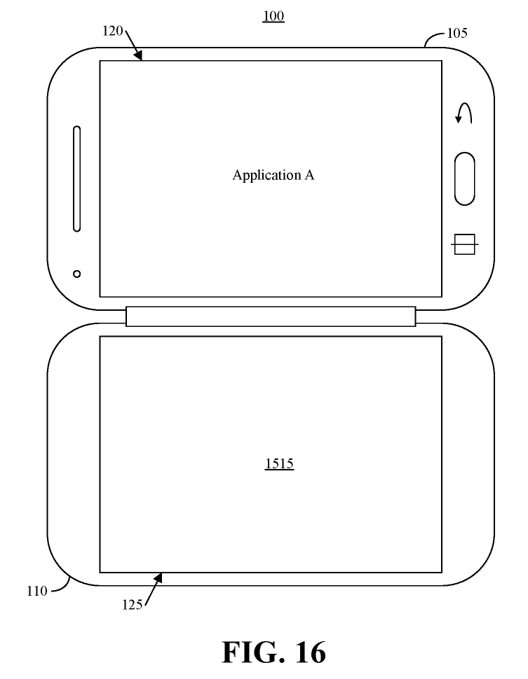

FIG. 16 is another diagram illustrating the content recommendation mode for mobile device 100. In the example of FIG. 16, the user has selected icon 1515 by tapping on icon 1515. Responsive to a user selection of icon 1515, mobile device 100 may execute the item represented by icon 1515 and display the item in full screen. For example, icon 1515 may represent an application or a Website. If an application, mobile device 100 may execute the application and display the application on screen 125 as described in landscape. If a Website, mobile device 100 may execute a browser, display the browser on screen 125 in landscape, and navigate to the Website represented by icon 1515. Application A may continue executing and is displayed in full screen uninterrupted on screen 120.

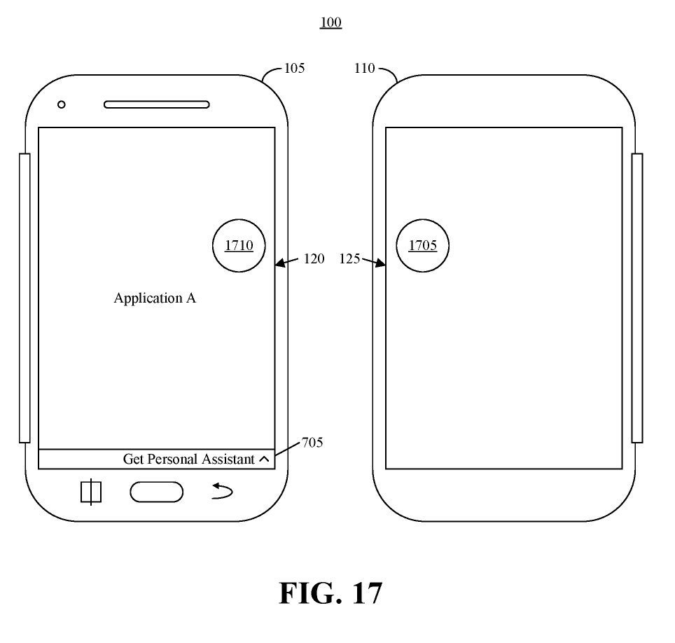

FIG. 17 is a diagram illustrating an exemplary gesture pad mode for mobile device 100. FIG. 17 illustrates an example where mobile device 100 is in the closed outward arrangement. In FIG. 17, mobile device 100 is positioned with screen 120 of display unit 105 facing forward so that a user may view screen 120. Display unit 110 and screen 125 are facing away from the user but are shown separately only to illustrate operation of the gesture pad mode.

In one embodiment, while in the closed outward arrangement and responsive to a particular user input, screen 125 may be operative as a gesture pad (e.g., a track pad) for controlling operation of mobile device 100. As an illustrative example, consider the case where application A is a camera application and a user wishes to take a picture of himself or herself, e.g., “take a selfie.” In that case, the user may activate the gesture pad mode by providing a predetermined user input to screen 125. For example, screen 125 may be initially off. Screen 125 may activate as a gesture pad responsive to a tap and hold on screen 125 by the user in particular operating contexts such as executing a particular application, displaying that application on screen 120, being in the closed outward arrangement, and receiving the selected user input requesting gesture pad mode. In the gesture pad mode, screen 125 may not display any content, but may detect touches and user gestures.

Referring to FIG. 17, screen 125 may have been placed in gesture pad mode as described. The user may again touch screen 125 as illustrated by touch 1705. Responsive to a further gesture such as swiping up, down, left, or right, the user input may be used to trigger an operation in application A such as taking a photo. In another example, application A may be a photo management application or a word processing application. In that case, having activated gesture pad mode, the user may provide user inputs to screen 125 in the form of gestures (e.g., swiping) to scroll through an image collection, a document, a Webpage, or the like. In one aspect, the gestures may be in any direction. In another aspect, the gestures may be limited to particular directions such as up and down or left and right.

Gesture pad mode helps users avoid physical impairments such as thumb fatigue. Gesture pad mode may be activated in a manner that avoids false positives. For example, as noted, the user may be required to tap and hold screen 125 for a predetermined amount of time to invoke gesture pad mode. Further, gesture pad mode may be limited to use with particular applications and/or when mobile device 100 is in particular arrangements. In another exemplary implementation, mobile device 100 may display or superimpose an indicator (e.g., indicator 1710) on screen 120 corresponding to the detected location of the user's touch on screen 125 while in gesture pad mode.

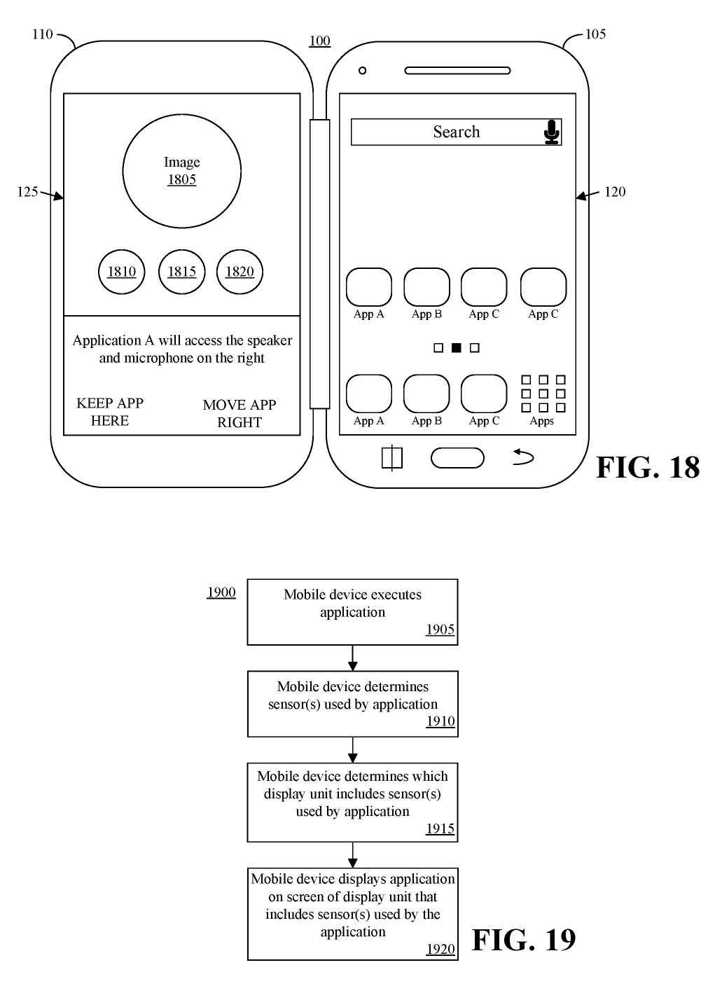

FIG. 18 is a diagram illustrating another exemplary mode of operation for mobile device 100. FIG. 18 illustrates an example where mobile device 100 may execute an application and display the application on a display unit that lacks one or more sensors needed and/or used by the application. For example, the user may have previously moved the application from displaying on screen 120 to screen 125. In the example of FIG. 18, mobile device 100 may receive a phone call. Accordingly, mobile device 100 may execute the telephone application and display the telephone application on screen 125. In the example of FIG. 18, the telephone application may display an image 1805 representing the caller, controls 1810, 1815, and 1820 for answering the call, ignoring the call, or initiating a video call, etc.

In this example, the microphone, speaker, and camera of mobile device 100 are implemented within display unit 105. Accordingly, mobile device 100 may detect that one or more sensors used by the telephone application are not present in display unit 110 where the application is displayed. Mobile device 100, in response, may display a message indicating that the application will access the needed sensors from display unit 105.

In another aspect, mobile device 100 may also provide selectable options to the user. One option may be to keep the telephone application displayed on screen 125. Another option may be to display the telephone application on screen 120, thereby moving telephone application from screen 125 to screen 120. Thus, responsive to the user selecting “KEEP APP HERE,” the telephone application remains displayed in full screen on screen 125. Responsive to the user selecting “MOVE APP RIGHT,” the telephone application is no longer displayed on screen 125 and is instead displayed on screen 120 of display unit 105.

In one exemplary embodiment, mobile device 100 may determine the sensors that are needed by an application when the application is executed and automatically display the application on the screen of the display unit that includes the needed sensors. FIG. 19 is a flow chart illustrating an exemplary method 1900 of managing applications for mobile device 100. Mobile device 100 may perform method 1900 automatically responsive to invoking or executing an application.

In block 1905, mobile device 100 may begin executing an application. Mobile device 100 may execute the application responsive to a user input selecting execution of the application or responsive an event such as an incoming telephone call, video call, or the like. In block 1910, responsive to execution of the application, mobile device 100 may determine one or more sensors of mobile device 100 used by the application.

In block 1915, mobile device 100 may determine which of the plurality of display units includes the sensor, or sensors as the case may be, used by the application. In block 1920, mobile device 100 may display the application on the screen of the display unit that includes the sensor(s) used by the application. It should be appreciated that mobile device 100 may display the application on the display screen of the display unit having the needed sensor(s) regardless of the screen on which the application may have been displayed in a prior, or immediately prior, execution.

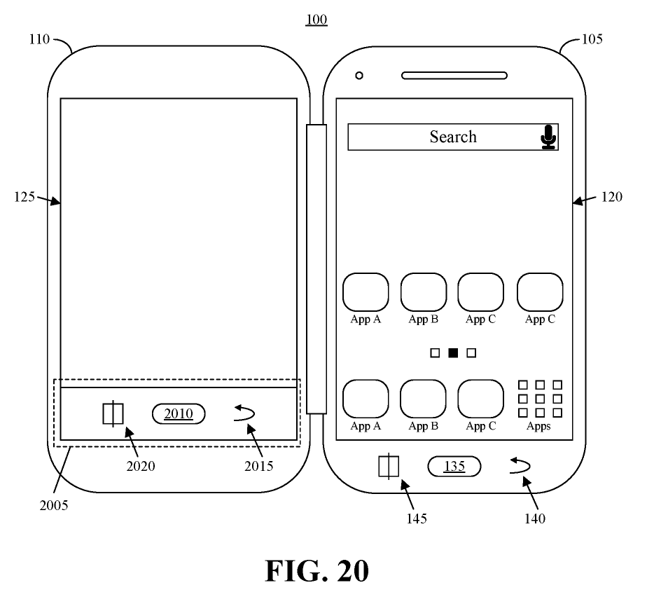

FIG. 20 is a diagram illustrating an exemplary software navigation mode of mobile device 100. In the example of FIG. 20, display unit 110 does not include physical controls such as home button 135, back button 140, or multitask mode button 145 as are implemented for display unit 105. Because screens 120 and 125 may operate completely independently in many operational modes, a user may wish to utilize the same functions on screen 125 for display unit 110 that are available as hardware controls for display unit 105. Accordingly, in one embodiment, responsive to a user input received on screen 125, mobile device 100 may display a software implemented navigation bar 2005 on screen 125.

In one example, the user may swipe up on screen 125 from the bottom to pull up and access software implemented navigation bar 2005. As pictured, software implemented navigation bar 2005 may include software implemented controls 2010, 2015, and 2020 that mimic the look and functionality of home button 135, back button 140, and multitask mode button 145, respectively, of display unit 105. Accordingly, the user may perform the same functions on display unit 110 through screen 125 using software implemented navigation bar 2005 that may be performed using the hardware controls of display unit 105.

Mobile device 100 may stop displaying software implemented navigation bar 2005 responsive to the user selecting one of the software controls 2010, 2015, or 2020. In another example, mobile device 100 may stop displaying software implemented navigation bar 2005 after the expiration of a predetermined amount of time during which the user does not select any of software controls 2010, 2015, or 2020. In still another example, mobile device 100 may stop displaying software implemented navigation bar 2005 responsive to a user swiping down or touching a part of screen 125 not occupied by software implemented navigation bar 2005.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the term “another” means at least a second or more.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se (i.e., is “non-transitory”). A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium. A non-exhaustive list of more specific examples of a computer readable storage medium may include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

As defined herein, the term “coupled” means connected, whether directly without any intervening elements or indirectly with one or more intervening elements, unless otherwise indicated. Two elements may be coupled mechanically, electrically, or communicatively linked through a communication channel, pathway, network, or system.

As defined herein, the term “executable operation” or “operation” is a task performed by a data processing system or a processor within a data processing system unless the context indicates otherwise. Examples of executable operations include, but are not limited to, “processing,” “computing,” “calculating,” “determining,” “displaying,” “comparing,” or the like. In this regard, operations refer to actions and/or processes of the data processing system, e.g., a computer system, or similar electronic computing device, that manipulates and transforms data represented as physical (electronic) quantities within the computer system's registers and/or memories into other data similarly represented as physical quantities within the computer system memories and/or registers or other such information storage, transmission or display devices.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” or similar language mean that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “plurality” means two or more than two.

As defined herein, the term “processor” means at least one hardware circuit configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or media) having computer readable program instructions thereon for causing a processor to carry out aspects of the present invention. Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

As defined herein, the term “computer readable program instructions” mean any expression, in any language, code or notation, of a set of instructions intended to cause a data processing system to perform a particular function. Computer readable program instructions for carrying out operations for the inventive arrangements described herein may be assembler instructions, instruction-set-architecture (ISA) instructions, machine instructions, machine dependent instructions, microcode, firmware instructions, state-setting data, or either source code or object code written in any combination of one or more programming languages, including an object oriented programming language and/or procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein. Computer readable program instructions may also be referred to as program code, software, applications, and/or executable code.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The corresponding structures, materials, acts, and equivalents of all means or step plus function elements that may be found in the claims below are intended to include any structure, material, or act for performing the function in combination with other claimed elements as specifically claimed.

A method of operating a mobile device including a plurality of display units may include, responsive to executing an application on the mobile device, determining, using a processor of the mobile device, a sensor of the mobile device used by the application, determining, using the processor, which of the plurality of display units includes the sensor used by the application, and displaying, using the processor, the application on a screen of the display unit that includes the sensor used by the application.

The method may include, responsive to a user input, moving a selected application from displaying on a screen of a first display unit of the plurality of display units to displaying on a screen of a second display unit of the plurality of display units.

The method may include, responsive to a user input, creating a combination shortcut using an application displayed on a screen of a first display unit of the plurality of display units and a second application displayed on a screen of the second display unit of the plurality of display units.

The method may include responsive to determining that the mobile device is in a predetermined arrangement, activating at least one screen of the plurality of display units in a low power mode using a low power mode color scheme and, responsive to a user gesture detected by the mobile device, exiting the low power mode and transitioning the at least one screen to operate using a normal operation mode color scheme.

The method may include responsive to detecting a selected operating context of the mobile device, displaying an intelligent assistant notification on a selected screen of at least one of the display units and, responsive to detecting a user selection of the intelligent assistant notification, displaying an intelligent assistant on the selected screen of the at least one of the display units, wherein the intelligent assistant includes at least one executable option determined from the operating context of the mobile device.

The method may include, responsive to detecting an operating context including an operating state of a screen of a first display unit of the plurality of display units and the mobile device being in a predetermined arrangement, displaying supplemental information for the operating context on a screen of a second display unit of the plurality of display units.

The method may include, responsive to detecting a user gesture on a selected screen of a display unit of the plurality of display units, displaying available applications installed on the mobile device on the selected screen.

The method may include, responsive to detecting an operating context including a selected application displayed on a screen of a first display unit of the plurality of display units, the mobile device being in a predetermined arrangement, and detecting a selected user input on a screen of a second display unit of the plurality of display units, implementing a gesture pad mode using the screen of the second display unit to control at least one operation of the selected application displayed on the screen of the first display unit.

A mobile device may include a plurality of coupled display units configured to rotate about an axis, wherein each display unit includes a screen. The mobile device may also include a processor within at least one of the display units. The processor is programmed to initiate executable operations including, responsive to executing an application, determining a sensor of the mobile device used by the application, determining which of the plurality of display units includes the sensor used by the application, and displaying the application on the screen of the display unit including the sensor used by the application.

The processor may be further programmed to initiate executable operations including, responsive to a user input, moving a selected application from displaying on the screen of a first display unit of the plurality of display units to displaying on the screen of a second display unit of the plurality of display units.

The processor may be further programmed to initiate executable operations including, responsive to a user input, creating a combination shortcut using an application displayed on the screen of a first display unit of the plurality of display units and a second application displayed on the screen of the second display unit of the plurality of display units.

The processor may be further programmed to initiate executable operations including, responsive to determining that the mobile device is in a predetermined arrangement, activating at least one of the screens in a low power mode using a low power mode color scheme and, responsive to a user gesture detected by the mobile device, exiting the low power mode and transitioning the at least one screen to operate using a normal operation mode color scheme.

The processor may be further programmed to initiate executable operations including, responsive to detecting a selected operating context of the mobile device, displaying an intelligent assistant notification on at least one of the screens and, responsive to detecting a user selection of the intelligent assistant notification, displaying an intelligent assistant on the at least one of the screens, wherein the intelligent assistant includes at least one executable option determined from the operating context of the mobile device.

The processor may be further programmed to initiate executable operations including, responsive to detecting an operating context including an operating state of the screen of a first display unit of the plurality of display units and the mobile device being in a predetermined arrangement, displaying supplemental information for the operating context on the screen of a second display unit of the plurality of display units.

The processor may be further programmed to initiate executable operations including, responsive to detecting a user gesture on a selected screen, displaying available applications installed on the mobile device on the selected screen.

The processor may be further programmed to initiate executable operations including, responsive to detecting an operating context including a selected application displayed on the screen of a first display unit of the plurality of display units, the mobile device being in a predetermined arrangement, and detecting a selected user input on the screen of a second display unit of the plurality of display units, implementing a gesture pad mode using the screen of the second display unit to control at least one operation of the selected application displayed on the screen of the first display unit.

A computer program product includes a computer readable storage medium having program code stored thereon. The program code is executable by a processor of a mobile device. The mobile device includes a plurality of display units. The processor may perform a method including, responsive to executing an application on the mobile device, determining, using the processor of the mobile device, a sensor of the mobile device used by the application, determining, using the processor, which of the plurality of display units includes the sensor used by the application, and displaying, using the processor, the application on a screen of the display unit including the sensor used by the application.

The method may include, responsive to a user input, creating a combination shortcut using an application displayed on a screen of a first display unit of the plurality of display units and a second application displayed on a screen of the second display unit of the plurality of display units.

The method may include, responsive to determining that the mobile device is in a predetermined arrangement, activating at least one screen of the plurality of display units in a low power mode using a low power mode color scheme and, responsive to a user gesture detected by the mobile device, exiting the low power mode and transitioning the at least one screen to operate using a normal operation mode color scheme.

The method may also include, responsive to detecting an operating context including a selected application displayed on a screen of a first display unit of the plurality of display units, the mobile device being in a predetermined arrangement, and detecting a selected user input on a screen of a second display unit of the plurality of display units, implementing a gesture pad mode using the screen of the second display unit to control at least one operation of the selected application displayed on the screen of the first display unit.

The description of the inventive arrangements provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

1. A method of operating a mobile device comprising a plurality of display units, the method comprising:
responsive to executing an application on the mobile device, determining, using a processor of the mobile device, a sensor of the mobile device used by the application;
determining, using the processor, which of the plurality of display units comprises the sensor used by the application; and
displaying, using the processor, the application on a screen of the display unit comprising the sensor used by the application.

2. The method of claim 1, further comprising:
responsive to a user input, moving a selected application that is executing and displayed on a screen of a first display unit of the plurality of display units from displaying on the screen of the first display unit to displaying on a screen of a second display unit of the plurality of display units.

3. The method of claim 1, further comprising:
responsive to a user input, creating a combination shortcut using a first application displayed on a screen of a first display unit of the plurality of display units and a second application displayed on a screen of the second display unit of the plurality of display units;
wherein at least one of the screens displays a list of recent applications from which at least one of the first application or the second application is selected for display in creating the combination shortcut.

4. The method of claim 1, further comprising:
responsive to determining that the mobile device is in a predetermined arrangement, activating at least one screen of the plurality of display units in a low power mode using a low power mode color scheme comprising a dark background and a lighter color to display information; and
responsive to a user gesture detected by the mobile device, exiting the low power mode and transitioning the at least one screen to operate using a normal operation mode color scheme.

5. The method of claim 1, further comprising:
responsive to detecting a selected operating context of the mobile device, displaying an intelligent assistant notification on a selected screen of at least one of the display units; and
responsive to detecting a user selection of the intelligent assistant notification, displaying an intelligent assistant on the selected screen of the at least one of the display units, wherein the intelligent assistant comprises at least one executable option determined from the operating context of the mobile device and historical usage of the mobile device.

6. The method of claim 1, further comprising:
responsive to detecting an operating context comprising an application executing on a screen of a first display unit of the plurality of display units and the mobile device being in a predetermined arrangement, displaying supplemental information relating to the application on a screen of a second display unit of the plurality of display units.

7. The method of claim 1, further comprising:
responsive to detecting a user gesture on a selected screen of a display unit of the plurality of display units displaying an application in full screen, displaying available applications installed on the mobile device on the selected screen.

8. The method of claim 1, further comprising:
responsive to detecting an operating context comprising a selected application displayed on a first screen of a first display unit of the plurality of display units, the mobile device being in a closed outward arrangement with the first display unit and a second display unit of the plurality of display units arranged back to back with the first screen and a second screen of the second display unit facing away from one another, and detecting a selected user input on the second screen, implementing a gesture pad mode using the second screen to control at least one operation of the selected application displayed on the first screen.

9. A mobile device, comprising:
a plurality of display units coupled to one another and configured to rotate about an axis, wherein each display unit comprises a screen;
a processor within at least one of the display units, wherein the processor is programmed to initiate executable operations comprising:
responsive to executing an application, determining a sensor of the mobile device used by the application;
determining which of the plurality of display units comprises the sensor used by the application; and
displaying the application on the screen of the display unit comprising the sensor used by the application.

10. The mobile device of claim 9, wherein the processor is further programmed to initiate executable operations comprising:
responsive to a user input, moving a selected application that is executing and displayed on a screen of a first display unit of the plurality of display units from displaying on the screen of the first display unit to displaying on the screen of a second display unit of the plurality of display units.

11. The mobile device of claim 9, wherein the processor is further programmed to initiate executable operations comprising:
responsive to a user input, creating a combination shortcut using a first application displayed on the screen of a first display unit of the plurality of display units and a second application displayed on the screen of the second display unit of the plurality of display units;
wherein at least one of the screens displays a list of recent applications from which at least one of the first application or the second application is selected for display in creating the combination shortcut.

12. The mobile device of claim 9, wherein the processor is further programmed to initiate executable operations comprising:
responsive to determining that the mobile device is in a predetermined arrangement, activating at least one of the screens in a low power mode using a low power mode color scheme comprising a dark background and a lighter color to display information; and
responsive to a user gesture detected by the mobile device, exiting the low power mode and transitioning the at least one screen to operate using a normal operation mode color scheme.

13. The mobile device of claim 9, wherein the processor is further programmed to initiate executable operations comprising:
responsive to detecting a selected operating context of the mobile device, displaying an intelligent assistant notification on at least one of the screens; and
responsive to detecting a user selection of the intelligent assistant notification, displaying an intelligent assistant on the at least one of the screens, wherein the intelligent assistant comprises at least one executable option determined from the operating context of the mobile device and historical usage of the mobile device.

14. The mobile device of claim 9, wherein the processor is further programmed to initiate executable operations comprising:
responsive to detecting an operating context comprising an application executing on the screen of a first display unit of the plurality of display units and the mobile device being in a predetermined arrangement, displaying supplemental information relating to the application on the screen of a second display unit of the plurality of display units.

15. The mobile device of claim 9, wherein the processor is further programmed to initiate executable operations comprising:
responsive to detecting a user gesture on a selected screen displaying an application in full screen, displaying available applications installed on the mobile device on the selected screen.

16. The mobile device of claim 9, wherein the processor is further programmed to initiate executable operations comprising:
responsive to detecting an operating context comprising a selected application displayed on the screen of a first display unit of the plurality of display units, the mobile device being in a closed outward arrangement with the first display unit and a second display unit of the plurality of display units arranged back to back with the screen of the first display unit and the screen of the second display unit facing away from one another, and detecting a selected user input on the screen of the second display unit of the plurality of display units, implementing a gesture pad mode using the screen of the second display unit to control at least one operation of the selected application displayed on the screen of the first display unit.

17. A computer program product comprising a non-transitory computer readable storage medium having program code stored thereon, the program code executable by a processor of a mobile device comprising a plurality of display units to perform a method comprising:
responsive to executing an application on the mobile device, determining, using the processor of the mobile device, a sensor of the mobile device used by the application;
determining, using the processor, which of the plurality of display units comprises the sensor used by the application; and
displaying, using the processor, the application on a screen of the display unit comprising the sensor used by the application.

18. The computer program product of claim 17, wherein the method further comprises:
responsive to a user input, creating a combination shortcut using a first application displayed on a screen of a first display unit of the plurality of display units and a second application displayed on a screen of the second display unit of the plurality of display units;
wherein at least one of the screens displays a list of recent applications from which at least one of the first application or the second application is selected for display in creating the combination shortcut.

19. The computer program product of claim 17, wherein the method further comprises:
responsive to determining that the mobile device is in a predetermined arrangement, activating at least one screen of the plurality of display units in a low power mode using a low power mode color scheme comprising a dark background and a lighter color to display information; and
responsive to a user gesture detected by the mobile device, exiting the low power mode and transitioning the at least one screen to operate using a normal operation mode color scheme.

20. The computer program product of claim 17, wherein the method further comprises:
responsive to detecting an operating context comprising a selected application displayed on a screen of a first display unit of the plurality of display units, the mobile device being in a closed outward arrangement with the first display unit and a second display unit of the plurality of display units arranged back to back with the screen of the first display unit and the screen of the second display unit facing away from one another, and detecting a selected user input on the screen of the second display unit of the plurality of display units, implementing a gesture pad mode using the screen of the second display unit to control at least one operation of the selected application displayed on the screen of the first display unit.
